(19) United States
(12) Patent Application Publication
(10) Pub. No.: US 2024/0158208 A1
(43) Pub. Date: May 16, 2024

(54) CENTROID ADJUSTMENT DEVICE SUITABLE FOR DIFFERENT TYPES OF LOADS

(71) Applicant: SICHUAN AEROSPACE SYSTEM ENGINEERING INSTITUTE, Chengdu (CN)

(72) Inventors: Yubin YANG, Chengdu (CN); Mingxing ZHANG, Chengdu (CN); Zhimin LIU, Chengdu (CN); Zhiqiang HAN, Chengdu (CN); Feng GUO, Chengdu (CN); Song CHEN, Chengdu (CN); Xiangzhen CHENG, Chengdu (CN); Hongliang LIU, Chengdu (CN); Guojun MA, Chengdu (CN); Yonggang XU, Chengdu (CN); Jianhua WU, Chengdu (CN); Shengneng CHEN, Chengdu (CN); Xuefeng GAO, Chengdu (CN); Lin ZHOU, Chengdu (CN); Yumin JIANG, Chengdu (CN)

(21) Appl. No.: 18/508,790

(22) Filed: Nov. 14, 2023

(30) Foreign Application Priority Data
Nov. 14, 2022 (CN) 202211417121.7

(51) Int. Cl. B66C 1/12

(52) U.S. Cl. CPC B66C 1/12

(57) ABSTRACT

The present invention discloses a centroid adjustment device suitable for different types of loads, which belongs to the field of transportation and support technology, including an upper adjustment assembly, a connecting module, and a loading device. The connecting module includes connecting pieces and chain connection assemblies adjustable in length, both upper ends of the connecting pieces and the chain connection assemblies are respectively mounted on opposite sides of the centroid of the upper adjustment assembly and can be adjusted to move toward or away from each other at an upper end of the upper adjustment assembly, and both lower ends of the connecting pieces and the chain connection assemblies are respectively mounted on opposite sides of the centroid of the loading device.

### TECHNICAL FIELD

The present invention belongs to the field of transportation and support technology, and specifically relates to a centroid adjustment device suitable for different types of loads.

### BACKGROUND

The loading process is always of great concern in various types of load supply and loading equipment. As the technology for supplying and loading different types of loads on a common platform develops, in order to shorten the lead time for goods loading or ammunition supply and loading, promote the popularization of supply and loading equipment, and meet the requirements of loading and transporting different types of loads on a common platform by supply and loading equipment, the loading equipment is required to supply and load different types of loads faster, more efficiently and more easily in different cases.

Many methods of supplying and loading different types of loads in different cases are adopted in the load supply and loading equipment, among which two are commonly used at present. The first method is to use different loading devices for different types of loads in different cases, and a fixed layout is adopted for each loading device to ensure that the orthocenter of the device is in line with the centroid of the load, so this method is relatively simple and convenient but low in loading efficiency, it is costly due to many bulky and heavy loading devices, and the loading process takes too long with poor safety. The second method is to adjust multiple mechanisms with different capacities in different cases, so as to ensure that the orthocenter of the loading device is in line with the centroid of the load, and the loading devices are generally designed with an MDOF manipulator to adapt to different types of loads in different cases and meet the loading requirements, so this method is high in loading efficiency but is also costly due to bulky and heavy loading devices, less versatile and not easily popularized in loading equipment.

Therefore, in order to improve the supply efficiency of different types of loads such as goods or ammunition, and to shorten the readiness time or operational response time of supply and loading equipment, a centroid adjustment device suitable for different types of loads is urgently needed to load different types of loads such as goods or ammunition under different capacities.

### SUMMARY

An objective of the present invention is to provide a centroid adjustment device suitable for different types of loads, which overcomes the existing problems that various types of hoisting mechanisms of complex structures are required for different types of loads under different capacities, the lead time for loading is long, and different supply and loading mechanisms are required for different types of loads such as goods or ammunition, thus effectively improving the comprehensive support performance of the supply and loading devices.

A technical solution is employed to achieve the above objective of the present invention. A centroid adjustment device suitable for different types of loads is provided, including an upper adjustment assembly, a connecting module, and a loading device; the connecting module includes connecting pieces and chain connection assemblies adjustable in length, both upper ends of the connecting pieces and the chain connection assemblies are respectively mounted on opposite sides of the centroid of the upper adjustment assembly and can be adjusted to move toward or away from each other at an upper end of the upper adjustment assembly, and both lower ends of the connecting pieces and the chain connection assemblies are respectively mounted on opposite sides of the centroid of the loading device.

Further, the upper adjustment assembly includes a rectangular frame, there are two connecting pieces and two chain connection assemblies, which are grouped in pairs, with one connecting piece and one chain connection assembly in a group, and the two groups are respectively located on opposite sides of the rectangular frame.

Further, a slide guide is further provided on each side of the rectangular frame on which the connecting piece and the chain connection assembly are mounted, and at least one movable sliding block, on which the connecting piece or the chain connection assembly on the same side is mounted, is provided on the slide guide.

Further, a plurality of mounting holes are further formed on the slide guide and evenly spaced on the rectangular frame, and a locking hole is further formed on the sliding block.

Further, a linear driver element for driving the sliding block to slide is further mounted on the rectangular frame.

Further, the linear driver element is an air cylinder, a hydraulic cylinder, or an electronic expansion link.

Further, the chain connection assembly includes two fasteners and a chain connected between the two fasteners, and the two fasteners are mounted on the upper adjustment assembly and the loading device, respectively.

Further, the loading device includes two side frames and synchronous fastening and locking mechanisms mounted between the two side frames, and the connecting piece and the chain connection assembly on the same side of the rectangular frame are hinged on one side frame or at both ends of the synchronous fastening and locking mechanisms.

Further, fixture blocks sliding on the side frame are mounted on both ends of the synchronous fastening and locking mechanism and fixedly locked to the side frame by bolts.

The present invention has the following beneficial effects.
1. According to the present invention, the upper ends of the connecting pieces and the chain connection assemblies can be adjusted to move toward or away from each other, and the chain connection assemblies are of a structure adjustable in length, so after the product is loaded on the loading device, the multi-step adjustment of the centroid can be enabled by adjusting the relative position between the upper ends of the connecting pieces and the chain connection assemblies and the length of the chain connection assemblies. In this way, the centroid can be adjusted according to the hoisting capacity, different types of loads can be hoisted in different cases without changing the structure, and the R&D cost can be reduced through centroid adjustment.
2. According to the present invention, the device is universal and can be applied to supplying and loading different types of loads such as goods or ammunition since the upper ends of the connecting pieces and the chain connection assemblies can be adjusted to move toward or away from each other, and the chain connection assemblies are adjustable in length, thus avoiding changes in the structure layout of the device and reducing the use of different types of hoisting mechanisms. The device is simple and reliable in structure, light in weight and small in size, and reduces the R&D and maintenance costs of supply and loading equipment.
3. According to the present invention, the upper ends of the connecting pieces or/and the upper ends of the chain connection assemblies can be adjusted according to the corresponding case before use of the device, so as to adapt to the centroid matching of different loads to be hoisted, shorten the lead time for load supply and loading, and allow for rapid load transfer or operational response.
4. According to the present invention, the device is highly adaptable, and the loading device may be transfer and hoisting equipment for various types of goods in different cases, ammunition loading equipment of various weapon platforms, etc. When in use, the device can be provided to transfer equipment for various types of goods, ammunition loading equipment of various weapon platforms, etc. At the same time, the present invention is simple in structure, easy to use, small in occupied area and highly adaptable. It may also serve as a separate hoisting and supply unit for in various field loading and supply operations, and is widely applied in civil and military fields.

### BRIEF DESCRIPTION OF THE DRAWINGS

The drawings, which are included to provide further understanding of the present invention, show exemplary embodiments of the present invention and together with the description thereof serve to explain the principles of the present invention, and are included in and form a part of the specification.

FIG. 1 is a structural diagram of a centroid adjustment device suitable for different types of loads according to the present invention;

FIG. 2 is a structural diagram in which a slide guide is fitted to a sliding block;

FIG. 3 is a schematic diagram of adjusting a loading device under different loads (small difference in centroid);

FIG. 4 is a schematic diagram of adjusting the loading device under different loads (large difference in centroid);

FIG. 5 is a schematic diagram showing the matching between hoisting points and centroids of different types of loads;

FIG. 6 is a distribution diagram of centroid when the loading device is unloaded;

FIG. 7 is a structural diagram of a driving structure;

FIG. 8 is a structural diagram of a transverse link structure; and

FIG. 9 is a structural diagram of a swing link structure;

FIG. 10 is a structural diagram of a swing link structure.

In which:
1. Upper adjustment assembly; 2. Connecting module; 3. Loading device;
11. Rectangular frame; 12. Slide guide; 13. Sliding block;
21. Connecting piece; 22. Chain connection assembly;
221. Fastener; 222. Chain;
31. Side frame; 32. Synchronous fastening and locking mechanism; 33. Fixture block; 34. Casing body;
321. Driving structure, 322. Transverse link assembly; 323. Swing link structure; 324. Stop structure;
3211. Adjusting base; 3212. Slider; 3213. Bidirectional threaded rod;
3221. Link; 3222. Mounting groove; 3223. Threaded pin; 3224. Chute;
3231. Swing link; 3232. Pin shaft; 3233. Long middle hole;
3241. Stopper; and 3242. Sliding pin.

### DETAILED DESCRIPTION

The present invention will be further described in detail below with reference to the drawings by embodiments. It could be understood that the embodiments described in detail herein are not intended to qualify the present invention, but merely to interpret the present invention. It should also be noted that, for the sake of description, only the parts related to the present invention are shown in the drawings.

It should be noted that the embodiments and features in the embodiments of the present invention may be combined with each other without conflict. The present invention will be described in detail below with reference to the drawings by embodiments.

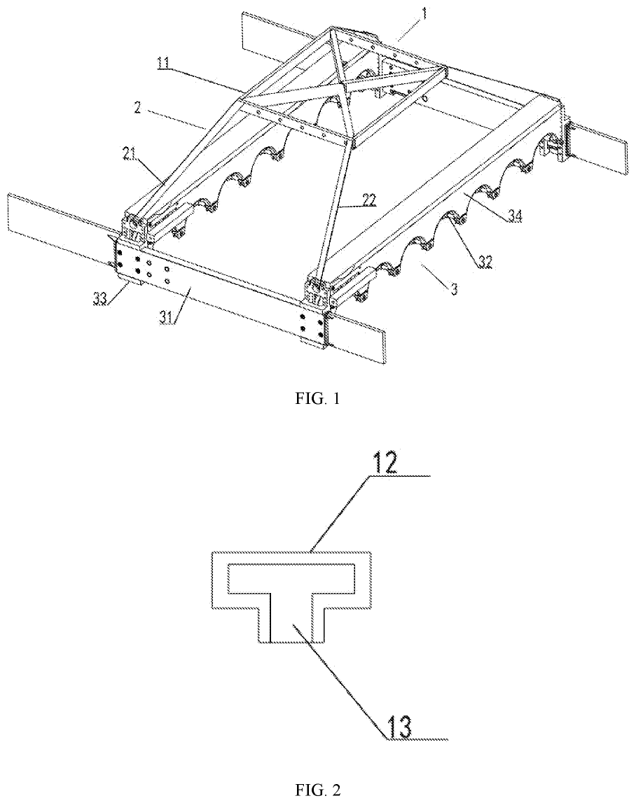

As shown in FIGS. 1 and 2, the present invention provides a centroid adjustment device suitable for different types of loads, including an upper adjustment assembly 1, a connecting module 2, and a loading device 3. The connecting module 2 is configured to connect the loading device 3 to the upper adjustment assembly 1, and the loading device 3 may be transfer and hoisting equipment for various types of goods, all kinds of weapons, and so on. The connecting module 2 includes connecting pieces 21 fixed in length and chain connection assemblies 22. The connecting piece 21 may be made of flexible non-metallic material or rigid metal material according to the load, with both ends connected to the upper adjustment assembly 1 and the loading device 3 by hinges. The chain connection assembly 22 is adjustable in length. In actual use, the length of the chain connection assembly 22 can be adjusted according to the centroid of different loads to ensure that the load centroid is in line with the hoisting point of the upper adjustment assembly 1 in the vertical direction, so as to keep a hoisting system level during hoisting and improve the efficiency and safety of goods or ammunition supply. However, the chain connection assembly 22 may be a metal or non-metal component adjustable in length, and each length of the chain connection assembly 22 corresponds to a load centroid. The length of the chain connection assembly 22 can be changed quickly. Of course, both ends of the chain connection assembly 22 may also be connected to the upper adjustment assembly 1 and the loading device 3 by hinges.

When designing the mounting process of the upper ends of the connecting piece 21 and the chain connection assembly 22, the upper ends of the connecting piece 21 and the chain connection assembly 22 are respectively mounted on opposite sides of the centroid of the upper adjustment assembly 1, while lower ends of the connecting piece 21 and the chain connection assembly 22 are respectively mounted on opposite sides of the centroid of the loading device 3. Specifically, when one connecting piece 21 and one chain connection assembly 22 are provided, regardless of the shape of the upper adjustment assembly 1, the upper end of the connecting piece 21 and the lower end of the chain connection assembly 22 are respectively mounted at both ends of the centroid axis of the upper adjustment assembly 1 and at both ends of the centroid axis of the loading device 3. When a plurality of connecting pieces 21 in one group and a plurality of chain connection assemblies 22 in one group are provided respectively, the upper ends of one group of connecting pieces 21 and one group of chain connection assemblies 22 are respectively mounted at both ends of the centroid axis of the upper adjustment assembly 1, while the lower ends of the group of connecting pieces 21 and the group of chain connection assemblies 22 are respectively mounted at both ends of the centroid axis of the loading device 3. The upper ends of the plurality of chain connection assemblies 22 in the same group and the upper ends of the plurality of connecting pieces 21 in the same group are spaced in the vertical direction of the centroid axis of the upper adjustment assembly 1, while the lower ends of the plurality of chain connection assemblies 22 in the same group and the lower ends of the plurality of connecting pieces 21 in the same group are spaced in the vertical direction of the centroid axis of the loading device 3. It should be noted that the centroid axis refers to a straight line extending to both ends along the centroid.

The upper ends of the connecting piece 21 and the chain connection assembly 22 can be adjusted to move toward or away from each other at an upper end of the upper adjustment assembly 1, so that the upper ends of the connecting piece 21 and the chain connection assembly 22 can approach or move away from each other, i.e., the distance between the upper end of the connecting piece 21 and the upper end of the chain connection assembly 22 can be adjusted.

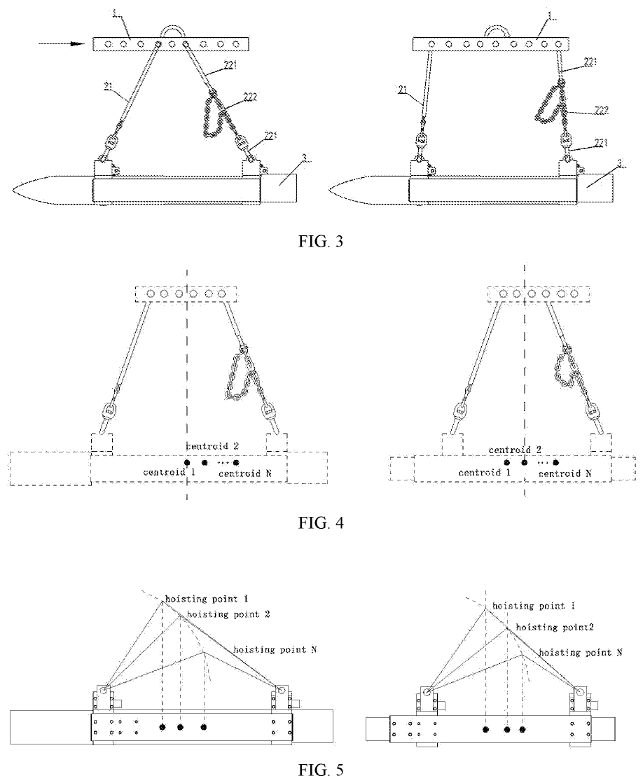

As shown in FIG. 3, positions where the upper end of the connecting piece 21 and the chain connection assembly 22 are mounted on the upper adjustment assembly 1 can be adjusted directly, so as to match the centroid of different loads (small difference in centroid). As shown in FIG. 4, positions where the upper end of the connecting piece 21 and the chain connection assembly 22 are mounted on the upper adjustment assembly 1 and the length of the chain connection assembly 22 can be adjusted at the same time, so as to match the centroid of different loads (large difference in shape such as diameter). In this way, the load centroid can be adjusted and matched accordingly in a small range.

As a further improvement of this embodiment, the upper adjustment assembly 1 includes a rectangular frame 11. In this case, there may be two connecting pieces 21 and chain connection assemblies 22, with one connecting piece 21 and one chain connection assembly 22 in a group, and the two groups are respectively mounted on opposite sides of the rectangular frame 11, i.e., an upper end of one connecting piece 21 and an upper end of one chain connection assembly 22 are respectively mounted on a long side or a short side of the rectangular frame 11, while an upper end of the other connecting piece 21 and an upper end of the other chain connection assembly 22 are respectively mounted on the other long side or short side of the rectangular frame 11. That is, when the upper ends of the chain connection assembly 22 and the connecting piece 21 are not adjusted, the upper ends of the two connecting pieces 21 and the two chain connection assemblies 22 are respectively mounted at four right-angled corners of the rectangular frame 11. When it is necessary to adjust the connecting piece 21 and the chain connection assembly 22 on the same long side or the same short side of the rectangular frame 11, the upper ends of the connecting piece 21 and the chain connection assembly 22 move toward or away from each other along the long side or the short side of the rectangular frame 11, so as to make the loading device 3 more stable while ensuring the adjustment of the load centroid.

As a further improvement of this embodiment, a slide guide 12 is further provided on each side of the rectangular frame 11 on which the connecting piece 21 and the chain connection assembly 22 are mounted. The slide guide 12 may be a guide rail separately provided on one side of the rectangular frame 11, and may also be one side of the rectangular frame 11. In addition, in order to ensure that the upper ends of the connecting pieces 21 and the chain connection assemblies 22 can move toward or away from each other, at least one movable sliding block 13, on which the connecting piece 21 or the chain connection assembly 22 on the same side is mounted, is provided on the slide guide 12. By sliding the sliding block 13 along the slide guide 12, the distance between the upper ends of the connecting piece 21 and the chain connection assembly 22 on the same side is reduced or increased. In this way, the upper ends of the connecting piece 21 and the chain connection assembly 22 on the same side can move toward or away from each other. By adjusting the fixed position of the sliding block 13, a wider matching range of the centroid of the load is available to adapt to different equipment and meet the use requirements for different types of loads, and the centroid of loads can be adjusted in a wide range.

At the same time, two movable sliding blocks 13 are further provided on the slide guide 12, and the upper ends of the connecting piece 21 or the chain connection assembly 22 on the same side are respectively mounted on the two sliding blocks 13. By sliding the two sliding blocks 13 along the slide guide 12, the distance between the upper ends of the connecting piece 21 and the chain connection assembly 22 on the same side is reduced or increased. In this way, the upper ends of the connecting piece 21 and the chain connection assembly 22 on the same side can move toward or away from each other. With this structure, the centroid of loads can be adjusted.

As a further improvement of this embodiment, in order to ensure that the sliding block 13 stops after sliding along the slide guide 12 to a fixed position, a plurality of mounting holes may be formed on the rectangular frame 11 and evenly spaced in the lengthwise direction of the slide guide 12. At the same time, a locking hole running through the sliding block 13 is formed in the sliding block 13, with its diameter matching that of the mounting hole. When the sliding block 13 slides to a fixed position, the locking hole on the sliding block 13 corresponds to one of the mounting holes on the sliding block 13. In this case, a pin shaft 3232 can be inserted into both of the corresponding locking hole and the mounting hole to lock the sliding block 13 to the slide guide so that the sliding block 13 stops after sliding to a fixed position, allowing for the centroid adjustment and a safer hoisting process. This locking way is mainly suitable for manual centroid adjustment.

As a further improvement of this embodiment, in order to automatically control the sliding and locking of the sliding block 13, linear driver elements may further be mounted on the rectangular frame 11. The linear driver element extends in the same direction as the axial direction of the slide guide 12 and is configured to automatically drive the sliding block 13 to slide and also to keep the driven sliding block 13 locked. Therefore, when the sliding block 13 is driven by the linear driver element, no additional locking structure is required to lock the sliding block 13 after sliding on the slide guide 12. In the present invention, the sliding block 13 is driven to slide on the slide guide 12 by the linear driver element, so that the upper ends of the chain connection assembly 22 or the connecting piece 21 on which the sliding block 13 is mounted can move synchronously, thus causing the upper ends of the chain connection assembly 22 and the connecting piece 21 to move toward or away from each other, and changing the spacing between the upper ends of the chain connection assembly 22 and the connecting piece 21. In this way, the movement of the upper end of the chain connection assembly 22 or that of the connecting piece 21 can be automatically adjusted, making it easier and simpler to adjust the centroid.

As a further improvement of this embodiment, the linear driver element is an air cylinder, a hydraulic cylinder, or an electronic expansion link. Of course, the linear driver element is not limited to an air cylinder, a hydraulic cylinder, or an electronic expansion link but is selected according to actual conditions.

As a further improvement of this embodiment, the chain connection assembly 22 includes two fasteners 221 and a chain 222 connected between the two fasteners 221. The two fasteners 221 may be two hinged joints and are mainly used to make both ends of the chain 222 easily connected to the upper adjustment assembly 1 and the loading device 3, with the upper end of the chain 222 swinging with respect to the upper adjustment assembly 1 while the lower end swinging with respect to the loading device 3. At the same time, in order to facilitate the length adjustment of the chain 222, a safety latch may also be mounted on one of the fasteners 221. When it is necessary to make the chain 222 shorter, a corresponding chain link of the chain 222 can be latched on the safety latch, so as to adjust the chain 222 and the centroid more easily. The length and position of the chain connection assembly 22 are adjusted in the vertical direction to meet the collinear design requirements of matching centroids of different types of loads in different cases.

As a further improvement of this embodiment, the loading device 3 includes two side frames 31 and synchronous fastening and locking mechanisms 32 mounted between the two side frames 31, and both ends of the synchronous fastening and locking mechanism 32 are respectively fixed to the two side frames 31. Specifically, there may be two synchronous fastening and locking mechanisms 32 spaced in the lengthwise direction of the side frame 31, i.e., the two synchronous fastening and locking mechanisms 32 and the two side frames 31 together form a rectangular frame. The connecting piece 21 and a hinge assembly on the same side of the rectangular frame 11 are hinged at both ends of the same side frame 31. Of course, the connecting piece 21 and the hinge assembly on the same side of the rectangular frame 11 may also be hinged at both ends of the same synchronous fastening and locking mechanism 32. Since the lower end of the connecting piece 21 and the lower end of the hinge assembly will not move relative to each other after being mounted, the lower end of the connecting piece 21 and the lower end of the hinge assembly can be mounted at will. That is, the connecting piece 21 and the hinge assembly on the same side of the rectangular frame 11 may also be hinged to the side frame 31, and the hinge assembly is hinged to the loading device 3. Finally, it is only necessary to ensure that the lower ends of the two connecting pieces 21 and the lower ends of the two chain connection assemblies 22 are respectively mounted at four right-angled corners of a rectangular frame formed by the two synchronous fastening and locking mechanisms 32 and the two side frames 31.

As a further improvement of this embodiment, U-shaped fixture blocks 33 are mounted on both ends of the synchronous fastening and locking mechanism 32 and clamped and fixedly locked to the side frame 31 by bolts. When not locked to the side frame 31, the fixture blocks 33 can slide on the side frame 31 to adjust the position where the synchronous fastening and locking mechanism 32 is mounted between the two side frames 31. Thus, in order to allow the fixture block 33 to be locked by bolts even after it has moved on the side frame 31, a plurality of sets of bolt holes may further be formed on the side frame 31 and evenly spaced in the lengthwise direction of the side frame 31. At the same time, a plurality of bolt holes are also formed on the fixture block 33. When the fixture block 33 is moved to a fixed position, the bolt holes on the fixture block 33 correspond to one set of bolt holes on the side frame 31. In this case, the fixture block 33 and the side frame 31 are fixedly locked with bolts running through the bolt holes thereon, so that the relative mounting positions of the two synchronous fastening and locking mechanisms 32 can be adjusted according to different loads during mounting, making the loading device 3 suitable for different types of loads.

As a further improvement of this embodiment, as shown in FIG. 7, the synchronous fastening and locking mechanism 32 includes a transverse link 3221 assembly 322 and a swing link 3231 structure 323. The transverse link 3221 assembly 322 drives the swing link 3231 structure 323 to move toward/away from each other synchronously, thereby allowing for synchronous fastening and release functions.

As shown in FIG. 9, the transverse link 3221 assembly 322 includes two links 3221 with the same lengthwise direction, i.e., the two links 3221 are parallel to each other, and at least one link 3221 can move back and forth in its lengthwise direction to make the two links 3221 move toward or away from each other. In order to avoid the two links 3221 from affecting each other when moving toward or away from each other, there may be a small spacing between the two links 3221, which occupies less space while satisfying the requirement of the swing link 3231 structure 323.

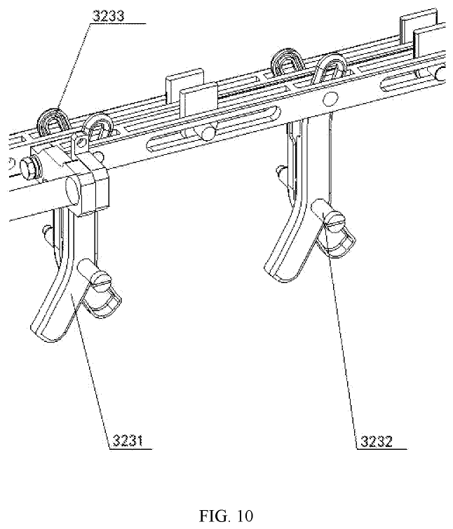

As shown in FIG. 10, the swing link 3231 structure 323 includes a plurality of swing links 3231 which are divided into two groups. The two groups of swing links 3231 are respectively mounted on the two links 3221, i.e., a plurality of swing links 3231 are mounted on each link 3221 and each can move longitudinally and transversely on the link 3221. However, when moving longitudinally and transversely on the link 3221, the swing link 3231 will not disengage from the link 3221. Meanwhile, after the two links 3221 are mounted without moving toward or away from each other, middle portions of the adjacent two swing links 3231 of the two links 3221 are hinged to each other. Here, it does not mean that two adjacent swing links 3231 on the same link 3221 are hinged to each other, but rather that the swing link 3231 on one link 3221 is hinged to the swing link 3231 on the other link 3221.

In actual use, since the upper ends of the swing links 3231 are restricted by the links 3221, the two swing links 3231 hinged to each other will swing around a hinge point when moving toward each other, and the swing link 3231 on one link 3221 and the front or rear swing link 3231 on the other link 3221 will swing toward each other, to form a clamping state. In this case, goods or ammunition can be fastened at this time, i.e., the goods or ammunition can be loaded. When moving away from each other, the two swing links 3231 hinged to each other swing around the hinge point. The swing link 3231 on one link 3221 swings away from the front or rear swing link 3231 on the other link 3221 to form an open state. In this case, goods or ammunition can be released.

In the present invention, the two adjacent swing links 3231 are evenly spaced on each link 3221. Since goods or ammunition can be loaded only with the cooperation between the swing link 3231 on the two links 3221, the ends of the two links 3221 may be aligned or misaligned when the two links 3221 are mounted. Since the fastening and release operations are realized only with the cooperation between the two swing links 3231 on the two links 3221, there is no need to mount the swing links 3231 at a left end of one link 3221 and at a right end of the other link 322 when the ends of the two links 3221 are aligned. The two links 3221 are misaligned by spacing between the two adjacent swing links 3231 on the same link 3221 when the ends of the two links 3221 are misaligned. In this case, the swing links 3231 can be mounted at both the left and right ends of the two links 3221. The spacing between the swing link 3231 at the end of one link 3221 and the swing link 3231 at the end of the other link 3221 is equal to that between the two adjacent swing links 3231 on the same link 3221.

As a further improvement of this embodiment, the clamping portion of the swing link 3231 is curved. The bending direction of the swing links 3231 on the same link 3221 is the same, and the bending direction of the swing links 3231 on one link 3221 is opposite to that of the swing links 3231 on the other link 3221, so that when the two links 3221 move toward each other, the swing links 3231 on one link 3221 are engaged with the front swing link 3231 or the rear swing link 3231 on the other link 3221, which has a better fastening effect for goods or ammunition. It should be noted here that the clamping portion of the swing link 3231 is the end of the swing link 3231 that clamps the goods or ammunition after swinging around the hinge point, and the specific bending shape of the clamping portion of the swing link 3231 can be adjusted based on the object to be fastened. For example, the clamping portion of the swing link 3231 may be arc-shaped or bent at a certain angle, so that the same structural form can be adapted to the fastening and release of different loads of the same shape. Of course, in this embodiment, the shapes of the clamping portions of the plurality of swing links 3231 on the same link 3221 may not be completely consistent, but it is necessary to ensure that the shapes of the clamping portions of the two swing links 3231 are the same when the two swing links 3231 on the two links 3221 cooperate with each other to fasten the same goods. When different shapes of goods or ammunition need to be loaded, the corresponding shapes of the swing links 3231 can be replaced to meet the loading requirements for different goods or ammunition.

As a further improvement of this embodiment, to prevent the swing links 3231 on one link 3221 from slipping when fitting with the front swing link 3231 or the rear swing link 3231 on the other link 3221 for fastening goods or ammunition, a clamping pad may also be provided at the clamping portion of the swing link 3231. The clamping pad may be made of rubber or other materials, and anti-skid patterns may also be provided on the clamping pad to enhance the friction between the clamping pad and the goods.

As a further improvement of this embodiment, each link 3221 is provided with mounting grooves 3222, the length direction of the mounting grooves 3222 is consistent with that of the link 3221, and the mounting groove 3222 penetrate through the upper surface of the link 3221 and the lower surface of the link 3221 simultaneously. The number and position of the mounting grooves 3222 on each link 3221 correspond to the number and position of the swing links 3231 on the link 3221. The width of the mounting groove 3222 is adapted to the thickness of the swing link 3231. Moreover, to facilitate the mounting of the swing link 3231, threaded pins 3223 are also installed in the mounting groove 3222, the length direction of the threaded pin 3223 is consistent with the width direction of the mounting groove 3222, and long middle holes 3233 are also provided at the upper end of the swing link 3231 and the upper end of the swing link 3231 is sleeved on the threaded pin 3223 by means of the threaded pin 3223 penetrating through the long middle hole 3233, so that not only the upper end of the swing link 3231 can swing on the threaded pin 3223, but also the swing link 3231 can move up and down on the threaded pin 3223, so when the two swing links 3231 hinged with each other swing around the hinge point, the upper end of the swing link 3231 can move up and down, left and right on the link 3221, which makes the mounting structure between the swing link 3231 and the link 3221 simpler.

As a further improvement of this embodiment, as shown in FIG. 9, the synchronous fastening and release mechanism also includes stop structures 324. The stop structure 324 is used for restricting and guiding the reciprocating motion of the link 3221. The stop structure 324 has two ends, and each stop structure 324 corresponds to one link 3221. Each stop structure 324 includes at least one stopper 3241 and the stopper 3241 is fixed on the device for installing the present invention during actual installation. For example, if the present invention is used for the goods transfer device, the stopper 3241 in the stop structure 324 is fixed on the goods transfer device. The stopper 3241 is further provided with a sliding pin 3242, wherein the length direction of the sliding pin 3242 is consistent with the thickness direction of the link 3221, and the two links 3221 are provided with chutes 3224. The width of the chute 3224 matches the diameter of the sliding pin 3242, the length direction of the chute 3224 is consistent with the movement direction of the link 3221, and the length of the chute 3224 is not less than the movement distance of the link 3221. The sliding pin 3242 is inserted into the chute 3224 on the corresponding link 3221 and the sliding pin 3242 cooperates with the chute 3224 to restrict the movement toward or movement away from each other of the links 3221 and restrict the up and down movement of the links 3221.

As a further improvement of this embodiment, the two adjacent swing links 3231 on the two links 3221 are hinged in the middle by pin shafts 323233, which makes it more convenient to hinge between the two adjacent swing links 3231 on the two links 3221. Of course, under the condition that the swing links 3231 synchronously swing during movement toward or movement away from each other of the links 3221, other ways can also be used for hinging between the two adjacent swing links 3231 on the two links 3221. Here, the two adjacent swing links 3231 on the two links 3221 refer to two swing links 3231 that correspond to each other and are hinged with each other on the two links 3221. The bending directions of the two swing links 3231 are opposite, and the cooperation between the two swing links 3231 cannot realize the fastening of goods or ammunition. The two swing links 3231 need to cooperate with the front swing link 3231 or the rear swing link 3231 to realize the fastening of goods or ammunition.

As a further improvement of this embodiment, the synchronous fastening and release mechanism also includes a driving structure 321 that drives the two links 3221 to move toward each other in the length direction. The driving structure 321 provides power for the two links 3221 to move toward or away from each other to realize the driving of the two links 3221, thus realizing the fastening and release of goods or ammunition.

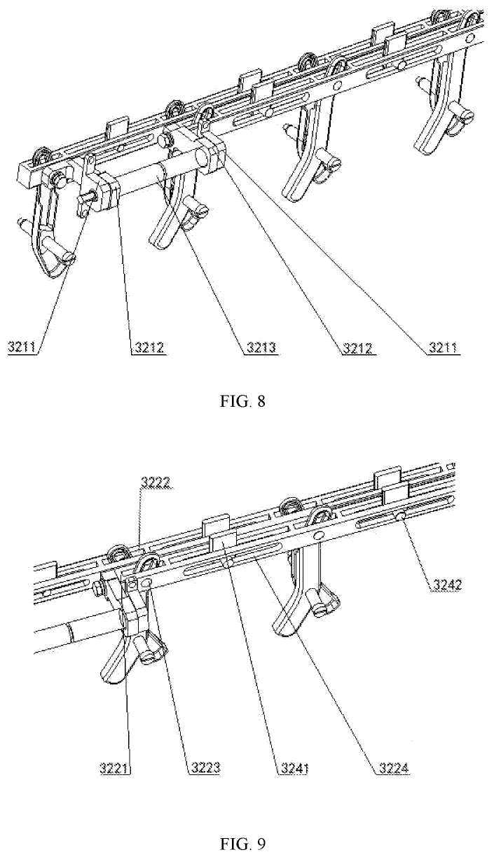

As a further improvement of this embodiment, as shown in FIG. 8, the driving structure 321 includes two adjusting bases 3211 and the adjusting bases 3211 are axle seats. During actual installation, the adjusting bases 3211 are fixed on the device for installing the present invention. For example, if the present invention is used for the goods transfer device, the adjusting bases 3211 in the present invention are fixed on the goods transfer device. Moreover, a bidirectional threaded rod 3213 is commonly installed on the two adjusting bases 3211 and the bidirectional threaded rod 3213 can rotate on the two adjusting bases 3211. The threads at both ends of the bidirectional threaded rod 3213 are rotated in opposite directions, i.e., one end of the bidirectional threaded rod 3213 is a forward thread and the other end of the bidirectional threaded rod 3213 is a reverse thread. Sliders 3212 are installed at the same end of the two links 3221, and threaded holes are provided on the two sliders 3212. The threaded hole on one slider 3212 is engaged with the thread on the left end of the bidirectional threaded rod 3213, while the threaded hole on the other slider 3212 is engaged with the thread on the right end of the bidirectional threaded rod 3213. When the bidirectional threaded rod 3213 rotates, due to different thread rotation directions at both ends of the bidirectional threaded rod 3213, the two sliders 3212 move in opposite directions on the bidirectional threaded rod 3213, so that the two sliders 3212 move toward or away from each other, thus driving the two links 3221 to move toward or away from each other. The bidirectional threaded rod 3213 is used to realize synchronous movement of the two links 3221, which not only is more convenient for driving the links 3221 but also relatively shortens the movement distance of the two links 3221, so that the response to fastening and release of goods or ammunition is faster, further improving the load loading efficiency and system reaction time.

As a further improvement of this embodiment, the driving structure 321 also includes a driving element that drives the bidirectional threaded rod 3213 to rotate. Since the bidirectional threaded rod 3213 needs to rotate, the driving element here is a drive motor and the drive motor is installed on the device for installing the present invention during installation, to make it simpler to drive the bidirectional threaded rod 3213 to rotate.

As a further improvement of this embodiment, to facilitate the installation of the fixture blocks 33 at both ends of the synchronous fastening and locking mechanism 32, the synchronous fastening and locking mechanism 32 also includes a casing body 34. The driving mechanism, the transverse link 3221 assembly 322, the swing link 3231 mechanism and the stop mechanism are jointly covered in the casing body 34. At this time, both ends of the pin shaft 3232 are fixed on the casing body 34, and the stopper 3241 on the stop mechanism is also fixedly installed on the inner wall of the casing body 34.

When the goods or ammunition needs to be loaded and fastened, the goods or ammunition is placed between the swing link 3231 on one link 3221 and the front swing link 3231 or the rear swing link 3231 on the other link 3221, and the bidirectional threaded rod 3213 is driven by a driving element or manually to rotate forward. When the bidirectional threaded rod 3213 rotates forward, it engages with the thread of the bidirectional threaded rod 3213 through the threaded hole on the slider 3212, and the two sliders 3212 move toward each other while the bidirectional threaded rod 3213 rotates forward. Through the cooperation between the sliding pin 3242 and the chute 3224, the two sliders 3212 drive the two links 3221 to move synchronously in a straight line while moving, so that the two links 3221 move toward each other. Since the upper end of the swing link 3231 is restricted by the threaded pin 3223, when the two links 3221 move toward each other, the two swing links 3231 hinged with each other swing around the hinge point. The swing link 3231 on one link 3221 swings toward the front swing link 3231 or the rear swing link 3231 on the other link 3221 to form a clamping state, so as to realize the fastening of goods or ammunition, that is, to realize the loading of goods or ammunition.

When the loaded and fastened goods or ammunition needs to be released, the bidirectional threaded rod 3213 is driven by a driving element or manually to rotate reversely. When the bidirectional threaded rod 3213 rotates reversely, it engages with the thread of the bidirectional threaded rod 3213 through the threaded hole on the slider 3212, and the two sliders 3212 move away from each other while the bidirectional threaded rod 3213 rotates reversely. Through the cooperation between the sliding pin 3242 and the chute 3224, the two sliders 3212 drive the two links 3221 to move synchronously in a straight line while moving, so that the two links 3221 move away from each other. Since the upper end of the swing link 3231 is restricted by the threaded pin 3223, when the two links 3221 move away from each other, the two swing links 3231 hinged with each other swing around the hinge point. The swing link 3231 on one link 3221 swings toward the front swing link 3231 or the rear swing link 3231 on the other link 3221 to form an open state, so as to realize the release of goods or ammunition.

As shown in FIG. 5, when the centroid of the loading device 3 without goods or ammunition is less different from that of the loading device 3 with goods or ammunition, or the centroid of the loading device 3 loaded with a previous batch of goods or ammunition is less different than that of the loading device 3 loaded with a subsequent batch of goods or ammunition, and it is now necessary to adjust the centroid of the loading device 3 with goods or ammunition before lifting, the rectangular frame 11 is lifted on the lifting equipment, and then the linear driver element drives the sliding block 13 to move forward or backward. The sliding block 13 will drive the upper end of the connecting piece 21 or the upper end of the chain connection assembly 22 to move while moving forward or backward, so that the distance between the upper end of the connecting piece 21 and the upper end of the chain connection assembly 22 becomes larger or smaller. When the lifting point of the rectangular frame 11 and the centroid of the loading device 3 are in the same vertical line, the linear driver element stops driving to complete the matching of centroid.

When the centroid of the loading device 3 without goods or ammunition is largely different from that of the loading device 3 with goods or ammunition, or the centroid of the loading device 3 loaded with a previous batch of goods or ammunition is largely different than that of the loading device 3 loaded with a subsequent batch of goods or ammunition, and it is now necessary to adjust the centroid of the loading device 3 with goods or ammunition before lifting, the rectangular frame 11 is lifted on the lifting equipment, the length of the chain 222 is adjusted, and the corresponding chain link of the chain 222 is latched on the safety latch after the length of the chain 222 is adjusted. Then, the linear driver element drives the sliding block 13 to move forward or backward. The sliding block 13 will drive the upper end of the connecting piece 21 or the upper end of the chain connection assembly 22 to move while moving forward or backward, so that the distance between the upper end of the connecting piece 21 and the upper end of the chain connection assembly 22 becomes larger or smaller. When the lifting point of the rectangular frame 11 and the centroid of the loading device 3 are in the same vertical line, the linear driver element stops driving to complete the matching of centroid.

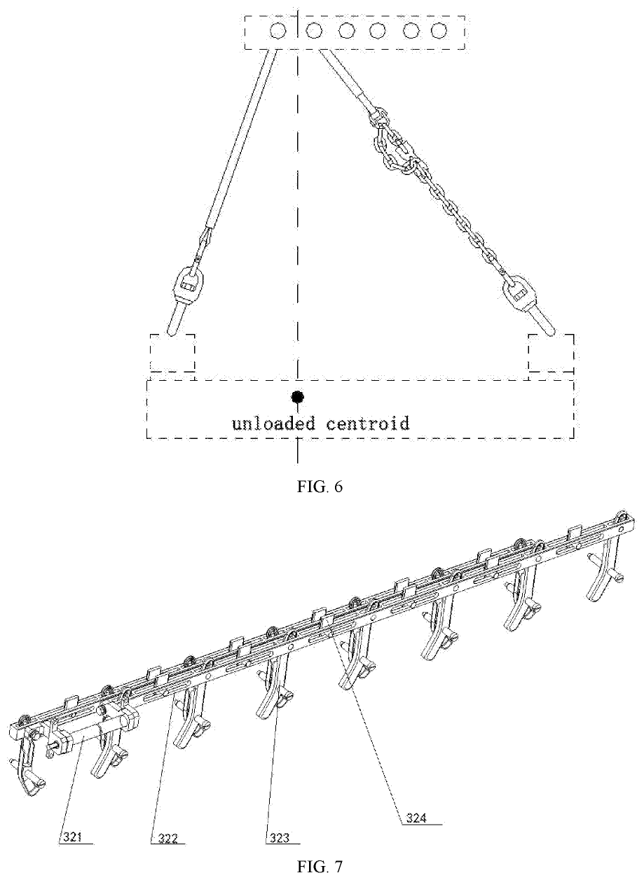

In the present invention, as shown in FIG. 6, the centroid of the loading device 3 under no load is analyzed, and the centroid matching of different loads under no load is realized by adjusting the length of the chain connection assembly 22 to complete the loading of the loading device 3 under various working conditions. The index parameters obtained during the analysis are shown in Table 1:

TABLE 1
Index Parameters of the Present Invention

| Applicable load | Applicable working | Bearing capacity of |
|---|---|---|
| specification | condition | loading device (t) |
| ≥6 | ≥6 | ≥6 |

It can be seen from the above that in the present invention, the applicable load specification, applicable working condition, and bearing capacity of the loading device 3 are all ≥6.

In the description of the specification, descriptions with reference to the terms “one embodiment”, “some embodiments”, “example”, “specific example”, or “some examples” mean that specific features, structures, materials or characteristics described in combination with the embodiment or example are contained in at least one embodiment or example of the present application. In the specification, the schematic expressions of the above terms do not necessarily refer to the same embodiments or examples. Moreover, the specific features, structures, materials, or characteristics described may be combined in any one or more embodiments or examples in a suitable manner. Furthermore, those of skill in the art may combine different embodiments or examples described in the specification and features of different embodiments or examples without contradiction.

Furthermore, the terms “first” and “second” are used merely for illustrative purposes and shall not be construed as indicating or implying relative importance or as implicitly specifying the number of technical features indicated. Thus, the features defined with the terms “first” and “second” may explicitly or implicitly include at least one of these features. Unless otherwise specifically defined, “multiple” means at least two, e.g. two or three, in the description of the present application.

Those of skill in the art should understand that the above embodiments are merely for clearly describing the present invention rather than limiting the scope of the present invention. Those of skill in the art may make other changes or variations based on the above disclosure, which still fall within the scope of the present invention.

1. A centroid adjustment device suitable for different types of loads, comprising an upper adjustment assembly (1), a connecting module (2), and a loading device (3). wherein the connecting module (2) comprises connecting pieces (21) and chain connection assemblies (22) adjustable in length, both upper ends of the connecting pieces (21) and the chain connection assemblies (22) are respectively mounted on opposite sides of the centroid of the upper adjustment assembly (1) and can be adjusted to move toward or away from each other at an upper end of the upper adjustment assembly (1), and both lower ends of the connecting pieces (21) and the chain connection assemblies (22) are respectively mounted on opposite sides of the centroid of the loading device (3).

2. The centroid adjustment device suitable for different types of loads according to claim 1, wherein the upper adjustment assembly (1) comprises a rectangular frame (11), there are two connecting pieces (21) and two chain connection assemblies (22), with one connecting piece (21) and one chain connection assembly (22) in a group, and the two groups are respectively located on opposite sides of the rectangular frame (11).

3. The centroid adjustment device suitable for different types of loads according to claim 2, wherein a slide guide (12) is further provided on each side of the rectangular frame (11) on which the connecting piece (21) and the chain connection assembly (22) are mounted, and at least one movable sliding block (13), on which the connecting piece (21) or the chain connection assembly (22) on the same side is mounted, is provided on the slide guide (12).

4. The centroid adjustment device suitable for different types of loads according to claim 3, wherein a plurality of mounting holes are further formed on the slide guide (12) and evenly spaced on the rectangular frame (11), and a locking hole is further formed on the sliding block (13).

5. The centroid adjustment device suitable for different types of loads according to claim 3, wherein a linear driver element for driving the sliding block (13) to slide is further mounted on the rectangular frame (11).

6. The centroid adjustment device suitable for different types of loads according to claim 5, wherein the linear driver element is an air cylinder, a hydraulic cylinder, or an electronic expansion link.

7. The centroid adjustment device suitable for different types of loads according to claim 1, wherein the chain connection assembly (22) comprises two fasteners (221) and a chain (222) connected between the two fasteners (221), and the two fasteners (221) are mounted on the upper adjustment assembly (1) and the loading device (3), respectively.

8. The centroid adjustment device suitable for different types of loads according to claim 1, wherein the loading device (3) comprises two side frames (31) and synchronous fastening and locking mechanisms (32) mounted between the two side frames (31), and the connecting piece (21) and the chain connection assembly (22) on the same side of the rectangular frame (11) are hinged on one side frame (31) or at both ends of the synchronous fastening and locking mechanisms (32).

9. The centroid adjustment device suitable for different types of loads according to claim 8, wherein fixture blocks (33) sliding on the side frame (31) are mounted on both ends of the synchronous fastening and locking mechanism (32) and fixedly locked to the side frame (31) by bolts.

10. The centroid adjustment device suitable for different types of loads according to claim 8, wherein the synchronous fastening and locking mechanism (32) comprises a transverse link assembly (322) and swing link mechanisms (323); the transverse link assembly (322) comprises two parallel links (3221) which can move relative to each other in the lengthwise direction; each swing link mechanisms (323) comprises a plurality of swing links (3231) respectively mounted on the two links (3221), an upper end of the swing link (3231) can move longitudinally and transversely on the links (3221), and middle portions of adjacent two swing links (3231) in the two links (3221) are hinged to each other.
